(19) United States
(12) Patent Application Publication
(10) Pub. No.: US 2009/0235469 A1
(43) Pub. Date: Sep. 24, 2009

(54) WASHING DEVICE AND MOUNTING DEVICE FOR THE SAME

(76) Inventor: Jyongmyong Lee, Sumida-ku (JP)

Correspondence Address: BURR & BROWN, PO BOX 7068, SYRACUSE, NY, 13261-7068, US

(21) Appl. No.: 12/278,299

(22) PCT Filed: Mar. 15, 2007
(86) PCT No.: PCT/JP2007/055183

§ 371 Date: May 12, 2009

(30) Foreign Application Priority Data
Mar. 16, 2006 (JP) 2006-072471
Jun. 28, 2006 (JP) 2006-177539

(51) Int. Cl. A46B 13/00; B23P 19/00; A47B 96/06

(52) U.S. Cl. 15/21.1; 29/700; 248/205.1

(57) ABSTRACT

A washing device including a motor having a rotating shaft attachment with a projection, and a washing member and core member fitted to the rotating shaft attachment. The washing member has a through hole for receiving the rotating shaft attachment, and the core member is disposed in the through hole. The core member has a through hole for receiving the rotating shaft attachment and engagement recesses, each of which is engageable with the projection. A mounting device for the washing device includes a pedestal on which the washing device is mounted, a first support member having horizontal and vertical portions that receive the pedestal for rotation about its axis, a second support member having a receiving portion for receiving the vertical or horizontal portions of the first support member, and a third support member for supporting the second supporting member on a sink.

### FIELD OF THE INVENTION

The present invention relates to a washing device suitable for washing eating utensils and cooking utensils, a washing member and a core member to be applied to the washing member for making up the washing device, and a mounting device for mounting the washing device onto a sink.

### BACKGROUND OF THE INVENTION

Japanese Patent No. 3,785,181 describes one example of a washing device for use in washing eating utensils and cooking utensils and a mounting device therefor. This washing device comprises a motor and a washing member made of a cylindrical sponge to be rotated with the motor. The motor has a rotating shaft and a rotating shaft attachment fitted to the rotating shaft, and the washing member is fitted to the rotating shaft attachment. The washing member has a through hole capable of receiving the rotating shaft attachment, so that the washing member may be fitted to the rotating shaft attachment. The rotating attachment is provided with plural projections, and the projections of the rotating shaft attachment engage with the a hole wall of the through hole of the washing member, when the washing member is fitted to the rotating shaft attachment.

Meanwhile, the rotation and stoppage of the rotation of the rotating shaft attachment are repeated every time the washing device is used. Further, the washing member fitted to the rotating shaft attachment is made of a sponge being a material softer than the projections of the rotating shaft attachment. Therefore, there was a problem that a hole wall of the through hole of the sponge that receives a torque from the projections of the rotating shaft attachment during the use is broken, and though the sponge is usable as the washing member, it is obliged to be exchanged early.

Furthermore, such a washing device is used in the state that it is fitted to a sink via a mounting device. Heretofore, the washing device is fitted to the sink by hanging plural hooks provided in the washing device to hooking holes provided in the mounting device. Owing to this, even when the posture of the washing device is preferably changed for convenience on use, it was actually difficult to do this.

### SUMMARY OF THE INVENTION

An object of the present invention is to enable a washing member in a washing device to be used for a longer time period. In addition, another object of the present invention is to provide a mounting device for the washing device, which can make the washing device to change the posture.

The present invention is directed to a core member (washing member-connecting core) for a washing device comprising a motor and a washing member (a sponge for a washing member), the motor comprising a rotating shaft and a rotating shaft attachment (a washing member-fitting rod) fitted to the rotating shaft and having at least one projection, the washing member being fitted to the rotating shaft attachment and having a through hole capable of receiving the rotating shaft attachment so as to fit it to the rotating shaft attachment, the core member being disposed in the through hole of the washing member of the washing device and fixed to a hole wall of the through hole, wherein the core member has a through hole capable of receiving the rotating shaft attachment, and has opposite end portions provided with engagement recesses (rotating shaft pin-hanging grooves) which are engageable with the projection of the rotating shaft attachment.

According to the present invention, the core member applied to the washing member to constitute the washing device is disposed inside the through hole of the washing member, and fixed to the hole wall of the through hole. When the washing member in which the core member is disposed and fixed is fitted to the rotating shaft attachment of the motor, the rotating attachment is received in that through hole and the through hole of the core member, and the engagement recess of the core member engages with the projection of the rotating shaft attachment. The washing member fitted to the rotating shaft attachment is rotated by actuating the motor, and rotates together with the rotating shaft attachment. Eating utensils and cooking utensils can be washed by pressing them against the washing member under rotation. At this time, the washing member is rotated by transmitting the torque of the rotating shaft attachment from the projection of the rotating shaft attachment to the core member via its engaging recess and further transmitting it from the core member to the washing member. That is, the rotating motion of the washing member is caused by indirectly transmitting the torque of the rotating shaft attachment to the washing member through the core member. This can prevent a breakage of the hole wall of the washing member with the projection of the rotating shaft attachment and resultant exchange of the washing member as would occur when the washing member is attached directly to the rotating shaft attachment and thus the torque is transmitted from the rotating shaft attachment directly to the washing member. As a result, the washing member can be used over an extended time period until the inherent lifetime possessed by the washing member ends.

Further, according to the present invention, since the engaging recesses of the core member are provided in both the end portions thereof, the engaging recess of the core member engage with the projections of the rotating shaft attachment even when the washing member is fitted to the rotating shaft attachment from either of the opposite end portions of the through hole of the washing member. For this reason, when one end portion of the washing member is worn out due to its use, for example, the washing member is once removed from the rotating shaft attachment, and then the washing member is fitted to the rotating shaft attachment from that one end portion thereof. Thereby, the other end portion of the washing member can be served for washing, so that the washing member can be further continuously used.

Moreover, when the washing member is used in such a manner that its opposite end portions are located up and down, respectively, for example, a detergent having been applied to the washing member and moved down can be located at an upper position by turning the washing member upside down and fitting it to the rotating shaft attachment. Thereby, the detergent can be more effectively utilized.

The present invention is further characterized in that the core member comprises a cylindrical body, and each engaging recess comprises a slit or groove which is opened to an end face of the cylindrical body, and the slit or groove comprises an axial portion extending in an axial direction of the cylindrical body and a circumferential portion crossing with the axial portion and extending in a circumferential direction of the cylindrical body.

According to the present invention, when the washing member attached with the core member is to be fitted to the rotating shaft attachment, the washing member is advanced in the axial direction of the rotating shaft attachment and then is turned around the axis line, thereby the projection of the rotating shaft attachment can reach the circumferential portion of the slit or groove as the engagement recess of the core member via the axial portion thereof. When the projection of the rotating shaft attachment engages with the circumferential portion of the engagement recess, the washing member can be prevented from moving in the axial direction of the rotating shaft attachment, that is, it can be prevented from getting out of the rotating shaft attachment.

The present invention is directed to an assembly to be applied to a washing device, which comprises a motor that has a rotating shaft and a rotating shaft attachment fitted to the rotating shaft and having at least one projection. The assembly is characterized by comprising a washing member and a core member, the washing member being fitted to the rotating shaft attachment and having a through hole capable of receiving the rotating shaft attachment so that the washing member may be fitted to the rotating shaft attachment, and the core member being disposed inside the through hole of the washing member and fixed to a hole wall of said through hole, and the core member having a through hole capable of receiving the rotating shaft attachment and opposed end portions with engagement recesses, each of which is engageable with the projection of the rotating shaft attachment.

According to the present invention, when the assembly comprising the washing member and the core member disposed inside its through hole and fixed to the hole wall is fitted to the rotating shaft attachment, the through hole of the washing member and that of the core member receive the rotating attachment, and the engaging recess of the core member engages with the projection of the rotating shaft attachment. The assembly fitted to the rotating shaft attachment is rotated together with the rotating shaft attachment by actuating the motor. Eating utensils and the cooking utensils can be washed by pressing them against the washing member of the assembly under rotation. At this time, the assembly is rotated by transmitting the torque of the rotating shaft attachment from the projection thereof to the core member via its engagement recess and further transmitting it from the core member to the washing member. That is, the rotating motion of the assembly is generated when the torque of the rotating attachment is transmitted to the washing member indirectly via the core member. Consequently, it is possible to prevent breakage of the hole wall of the washing member with the projection of the rotating shaft attachment and resultant exchange of the washing member as would occur when only the washing member is directly fitted to the rotating shaft attachment and thus the torque is transmitted from the rotating shaft attachment directly to the washing member. As a result, the washing member can be used over an extended time period until the inherent life of the washing member is exhausted.

Further, according to the present invention, since the engagement recesses of the core member are provided in both the end portions thereof, the engagement recess of the core member is fitted to the projection of the rotating shaft attachment even when the washing member is fitted to the rotating shaft attachment from either of the opposite sides of the through hole of the washing member. Consequently, when one end portion of the washing member is worn out due to the use thereof, for example, the washing member is once removed from the rotating shaft attachment, and then the washing member is fitted to the rotating shaft attachment from the side of the one end portion thereof, so that the other end portion of the washing member can be served for washing. Thereby, the washing member can be further continuously used.

In addition, when the washing member is used in such a manner that its opposite end portions are positioned up and down, respectively, for example, a detergent having been applied to the washing member and descended therein can be positioned upwardly by turning the washing member upside down and fitting it to the rotating shaft attachment. Thus, the detergent can be more effectively utilized.

The present invention is further characterized in that the core member is positioned in an axially central portion of the through hole of the washing member.

According to the present invention, since the core member is positioned in an axially central portion of the through hole of the washing member, the opposite end portions of the washing member made of a sponge, for example, can be rendered coreless and flexible, which is more suitable for washing.

The present invention is further characterized in that the core member comprises a cylindrical body, and the engagement recesses comprise grooves or notches having axial portions which are open to respective end faces of the cylindrical body and extending in an axial direction of the cylindrical body and circumferential portions crossing with the axial portions and extending in a circumferential direction of the cylindrical body.

According to the present invention, when the washing member having the core member fitted thereto is to be fitted to the rotating shaft attachment, the washing member is advanced in the axial direction of the rotating shaft attachment and then is turned around the axis line, thereby the projection of the rotating shaft attachment can reach the circumferential portion of the engagement recess of the core member via the axial portion thereof. The projection of the rotating shaft attachment engages with the circumferential portion of the engagement recess, so that the washing member can be prevented from moving in the axial direction of the rotating shaft attachment, that is, it can be prevented from getting out of the rotating shaft attachment.

The present invention is further characterized in that the washing member comprises a sponge, the through hole of the washing member has a round cross section, and the core member has a cylindrical face provided with a number of hooks (of a hook-like structure) which can be caught by the hole wall of said through hole.

According to the present invention, when a number of the hooks defining the cylindrical face of the core member are caught by a number of depressions opened to the hole wall of the through hole of the sponge, the core member is firmly fixed to the sponge.

The present invention is further characterized in that the washing member comprises a cylindrical sponge, and the sponge has a plurality of vertical grooves provided open to the outer peripheral face thereof and extending in the axial direction thereof.

According to the present invention, since the cylindrical sponge is provided with a plurality of the vertical grooves extending in the axial direction thereof, the sponge can possess ridge portions, between the vertical grooves, which impinge upon a surface of an object to be washed and are likely to be elastically deformed following the surface, when washing is done. Since such ridge portions are likely to contact the surface of the object to be washed, a highly washing effect can be obtained.

The present invention is further characterized in that the vertical grooves are of a rectangular or V-like cross sectional shape.

According to the present invention, the rectangular shape or the V-like shape can be selected and employed as the cross sectional shape of the vertical groove.

The present invention is further characterized in that a plurality of cuts (cut grooves) extending in the circumferential direction of the sponge.

According to the present invention, since a plurality of the cuts are formed in the circumferential direction of the sponge, the ridge portions are divided into small segments, so that it can more easily follow the surface of the object to be washed.

The present invention is further characterized in that the washing member comprises a cylindrical sponge, and the sponge has a plurality of notches provided at its opposite end portions and opened to the outer peripheral face thereof.

According to the present invention, since the opposite end portions of the sponge which are particularly more served for washing can be made more flexible, the washing power of the sponge can be further improved.

The present invention is further characterized in that the washing member is made of a sponge which comprises a cylindrical portion and a pair of semispherical portions continued to the opposite end portions of the cylindrical portion, respectively, and the through hole extends through the cylindrical portion and both the semispherical portions.

According to the present invention, the semispherical portions are suitable particularly for washing the bottom of a deep vessel.

The present invention is directed to a washing device, and comprises a motor and an assembly, the motor comprising a rotating shaft and a rotating shaft attachment fitted to the rotating shaft and having at least one projection, the assembly comprising a washing member and a core member, the washing member being detachably fitted to the rotating shaft attachment and having a through hole capable of receiving the rotating shaft attachment so that the washing member may be fitted to the rotating shaft attachment, and the core member being disposed inside the through hole of the washing member and fixed to a hole wall of said through hole, the core member having a through hole capable of receiving the rotating shaft attachment and opposite end portions provided with engagement recesses engageable with the projection of the rotating shaft attachment.

According to the present invention, since the assembly fitted to the rotating shaft attachment of the motor is rotated together with the rotating shaft attachment by actuating the motor. Eating utensils and cooking utensils can be washed by pressing them against the washing member of the assembly under rotation. At this time, the assembly is rotated by transmitting the torque of the rotating shaft attachment from the projection of the rotating attachment to the core member via the engagement recess thereof and further transmitting it from the core member to the washing member. That is, the rotating motion of the assembly is generated by transmitting the torque of the rotating shaft attachment to the washing member indirectly through the core member. Consequently, it is possible to prevent breakage of the hole wall of the washing member with the projection of the rotating shaft attachment and incident exchange of the washing member and the resultant exchange of the washing member as would occur when the washing member is directly fitted to the rotating shaft attachment and thus the torque is transmitted from the rotating shaft attachment directly to the washing member. As a result, the washing member can be used over an extended time period until the inherent life of the washing member is exhausted.

In addition, according to the present invention, since the engagement recesses of the core member in the assembly are provided in the opposite end portions of the core member, even when the washing member is fitted to the rotating shaft attachment from either of the opposite end portions of the through hole of the washing member, the engagement recess of the core member engages with the projection of the rotating shaft attachment. Consequently, when one end portion of the washing member is worn out due to the use thereof, for example, the washing member is once removed from the rotating shaft attachment, and the washing member is fitted to the rotating shaft attachment from that one end portion thereof, so that the other end portion of the washing member can be served for washing. Thereby, the washing member can be further continuously used.

In addition, when the washing member is used in such a manner that its opposite end portions are positioned up and down, respectively, for example, a detergent having been applied to the washing member and descended therein can be positioned upwardly by turning the washing member upside down and fitting it to the rotating shaft attachment. Thus, the detergent can be more effectively utilized.

The present invention is directed to a assembling device for the assembly composed of the washing member and the core member, and comprises a casing which is capable of receiving the core member, and insertable into the through hole of the washing member and is longer than the through hole of the washing member, the casing comprising two segments (a barrel portion and a cap portion) separable from each other, wherein when the casing in which the core member is received is divided into the two segments, a part of the core member is exposed outside.

According to the present invention, when the casing having the core member received therein is inserted into the through hole of the washing member and then a part of the casing and a remaining part are pulled out from the through hole of the washing member, respectively, the core member can be disposed inside the through hole of the washing member. Thereby, the assembly composed of the washing member and the core member can be obtained. Since the casing is longer than the length of the through hole of the washing member, the casing can be partially projected outwardly from the opposite ends of the through hole, when the casing is inserted into the through hole. Moreover, the casing can be pulled outside from the through hole by grasping the projected portions thereof.

The present invention is directed to a mounting device for mounting a washing device on a sink, the washing device comprising a motor and a washing member, the motor comprising a rotating shaft and a rotating shaft attachment fitted to the rotating shaft, and the washing member being fitted to the rotating shaft attachment. The invention is characterized by comprising a pedestal, a first support member, a second support member (an arm receiving board portion) and a third support member (a sink-installing portion), the pedestal comprising a base portion (a first turning portion) and a mounting portion (a second turning portion) on which the washing device is mounted, the first support member comprising a horizontal portion (a pedestal portion and a connecting portion) for receiving the base portion of the pedestal turnable around an axis thereof and a vertical portion (a back portion) continued to the horizontal portion and extending vertically, the second support member having a receiving portion capable of receiving the vertical portion or the horizontal portion of the first support member, and the third support member being adapted for supporting the second supporting member to the sink.

According to the present invention, since the pedestal is turnable, around its axis, above the first support member supporting it, the washing device fitted to the pedestal can be turned together with the pedestal, so that the posture of the washing device can be changed. Further, the posture of the washing device can be changed by an object received in the receiving portion of the second support member from the vertical portion to the horizontal portion of the first support member, for example.

The present invention is further characterized in that the mounting portion of the pedestal is pivotably fitted to its base portion, and the pedestal has a maintaining means (a fixing means) for maintaining the posture of the mounting portion after it is pivotably moved.

According to the present invention, the washing device can be tilted in such a manner that its axis is crossed with a vertically axial line, by pivotably moving the mounting portion on which the washing device is mounted, relative to the base portion of the pedestal. This tilted state can be maintained by the means for maintaining the posture of the mounting portion after the pivotal movement.

The present invention is further characterized in that the maintaining means comprises a diagonal brace capable of being fitted to the mounting portion.

According to the present invention, the tiled state of the mounting portion of the pedestal can be maintained via the diagonal brace.

The present invention is characterized in that the maintaining means comprises a stopper provided for the mounting portion.

According to the present invention, the tilted state of the mounting portion of the pedestal can be maintained by contacting the stopper of the mounting portion to the base portion of the pedestal.

According to the present invention, the life span of the washing member can be prolonged. In addition, the posture of the washing device can be changed.

### BRIEF DESCRIPTION OF THE DRAWINGS

FIG. 1 is a perspective view schematically illustrating a washing device according to the present invention.

FIG. 2 is a perspective view illustrating a motor and a rotating shaft attachment of the washing device.

FIG. 3(a) is a perspective view illustrating a washing member and a core member to be inserted into a through hole of the washing member.

FIG. 3(b) is a perspective view of an assembly in which the core member is disposed in a through hole of the washing member, and the washing member is shown by imaginary lines.

FIG. 4 is a perspective view of the core member.

FIG. 5 is a perspective view of one embodiment of the washing member provided with vertical grooves.

FIG. 6 is a perspective view of another embodiment of the washing member.

FIG. 7 is a perspective view of a further embodiment of the washing member.

FIG. 8 is a perspective view of a still further embodiment of the washing member.

FIG. 9 is perspective view of a still further embodiment of the washing member.

FIG. 10 is a front view of a still further embodiment of the washing member.

FIG. 11 is a perspective view of one embodiment of the core member provided with a number of hooks.

FIG. 12 is a plan view of the core member shown in FIG. 11.

FIG. 13 is a perspective view of another embodiment of the core member provided with a number of the hooks.

FIG. 14 is a perspective view of a further embodiment of the core member provided with a number of the hooks.

FIG. 15 is an exploded perspective view of an assembling device before the core member is received.

FIG. 16 is a front view of the assembling device having the core member received therein before the assembling device is inserted into the through hole of the washing member.

FIG. 17 is a front view of the assembling device which is inserted into the through hole of the washing member.

FIG. 18 is a front view of the assembling device in the state that a cap portion is pulled out from the through hole of the washing member after the assembling device has been inserted into the through hole of the washing member.

FIG. 19 is a sectional view of the washing member having the core member remaining in the through hole after a body portion of the assembling device is pulled out from the through hole of the washing member.

FIG. 20 is a front view illustrating a rotating shaft attachment and a washing member as a further embodiment before it is fitted to the rotating shaft attachment.

FIG. 21 is a front view illustrating the rotating shaft attachment and the washing member shown in FIG. 20 which is fitted to the rotating shaft attachment.

FIG. 22 is a front view of two washing members fitted to the rotating shaft attachment.

FIG. 23 is a schematically perspective view of a washing device-mounting device together with the washing device.

FIG. 24 is an exploded side view of the mounting device for the washing device.

FIG. 25 is a side view of the mounting device holding the washing device in a tilted state.

FIG. 26 is a side view illustrating a pedestal and a first support member supporting the pedestal in another embodiment of the mounting device.

FIG. 27 is a side view of the pedestal and the first support member shown in FIG. 26 for supporting the washing device in the tilted state.

FIG. 28 is a perspective view of the first support member and the second support member of the mounting device.

FIG. 29 is a perspective view of the second support member and the third support member of the mounting device.

### DETAILED DESCRIPTION OF THE INVENTION

### Washing Device

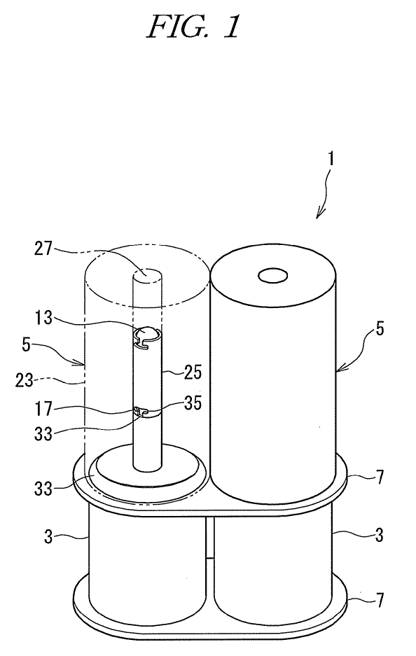

Referring to FIG. 1, a reference numeral 1 denotes a washing device according to one embodiment of the present invention. The washing device 1 comprises two motors 3, and two assemblies 5 to be driven by the motors 3, respectively. Both the motors 3 are arranged in parallel, and connected to each other by a pair of opposed plates 7. The assemblies 5 are both arranged adjacently to each other. In this washing device 1, an object to be washed (not shown) such as a eating utensil or a cooking utensil can be washed by inserting the object between both the assemblies 5 rotated or by pressing it against one or both of the assemblies 5. Ordinarily, washing is performed in the state that the below-mentioned washing members 23 of the assemblies 5 are soaked with water and a detergent is applied thereto. The assemblies 5 (more specifically the below-mentioned washing members 23) both rub off dirt from the surface of the object which is inserted between them or pressed thereagainst. The washing device 1 may comprise one motor 3 and one assembly 5.

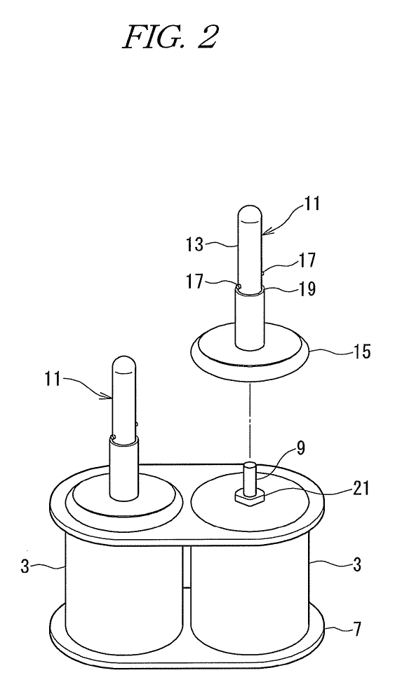

As shown in FIG. 2, the motor 3 comprises a rotating shaft 9 and a rotating shaft attachment 11 (hereinafter referred to briefly as “attachment”) which is fitted to the rotating shaft 9 and rotated therewith. The attachment 11 comprises a shaft portion 13 having a round cross sectional shape, a disc plate 15 continued to a base end (lower end) of the shaft portion, a pair of projections 17 located away from each other by 180° around a peripheral face of the shaft portion 13, and a stepped portion 19 located immediately under both the projections 17. When the attachment 11 is fitted to the rotating shaft 9 of the motor 3, the lower end portion of the shaft portion 13 is fitted to the rotating shaft 9 of the motor 3, and engages with an angular base portion 21 of the rotating shaft 9. The disc plate 15 covers the periphery of the rotating shaft 9 of the motor 3. Instead of the two projections 17 shown, one or three or more projections may be employed.

### Assembly of Washing Member and Core Member

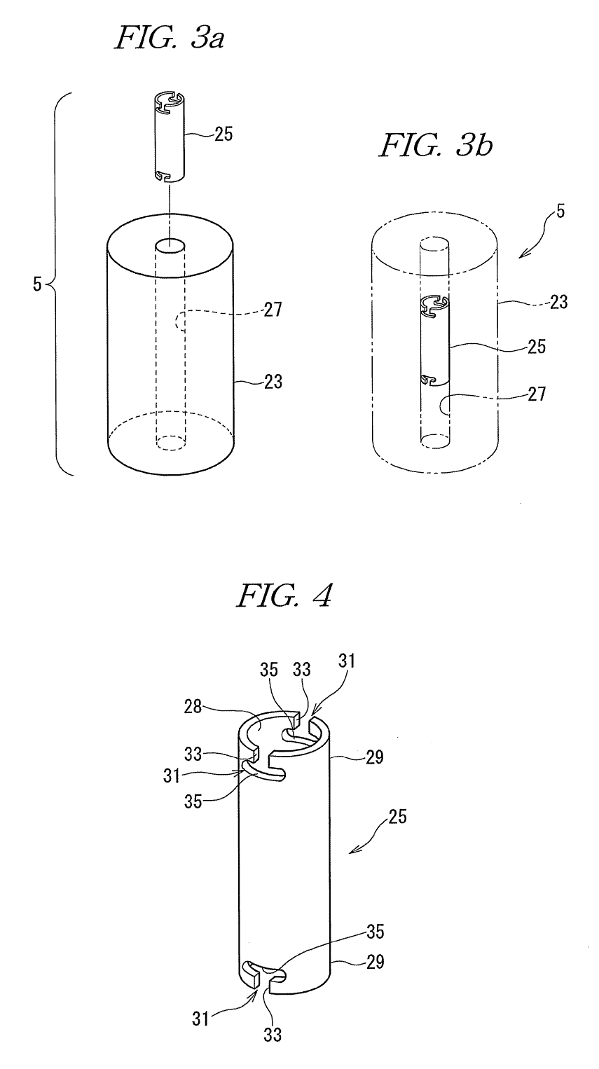

As shown in FIG. 3a and FIG. 3b, the assembly 5 comprises the washing member 23 and a core member 25. The washing member 23 shown is made of a cylindrical sponge, and has a through hole 27 which extends along the axis of the sponge and is opened to opposite end faces thereof. The through hole 27 has a round cross sectional shape. The washing member 23 is detachably fitted to the attachment 11, more specifically the shaft portion 13 of the attachment 11. On fitting, the through hole 27 of the washing member 23 receives the shaft portion 13 of the attachment 11. The core member 25 is constituted by a cylindrical body shorter than the washing member 23 and made of a plastic material, for example, and it is coaxially disposed inside the through hole 27 of the washing member 23, and fixed to a hole wall of the through hole 27. The core member 25 is preferably disposed in an axially central portion of the through hole 27. This makes the opposite end portions of the washing member 23 more flexible as compared with the central portion in which the core member 25 is disposed. Such opposite end portions exhibit a good washing effect in washing an inner surface of the object to be washed, like glass or tea cup.

As shown in FIG. 4, the core member 25 has a through hole 28, and each end portion 29 thereof has a pair of engagement recesses 31. The number (two) of the engagement recesses 31 of each end portion 29 of the core member 25 corresponds to the number (two) of the projection 17 of the attachment 11 of the motor 3. The engagement recess 31 comprises a slit (notch) totally forming a T-shape, and the slit has a axial portion 33, which is opened to an end face of the core member 25, and extends in its axial direction, and a circumferential portion 35 crossing the axial portion 33 and extending in a circumferential direction of the core member 25. The engagement recess 31 may be a groove (not shown) provided in an inner face of the core member 25 instead of the slit shown as an example.

As shown in FIG. 1, when the assembly 5 is fitted to the shaft portion 13 of the attachment 11 and the shaft portion 13 of the attachment 11 is received in the through hole 27 of the washing member 23, the through hole 28 of the core member 25 receives the shaft portion 13 of the attachment 11, the engagement recesses 31 of the core member 25 engage with the projections 17 of the attachment 11, and the core member 25 seats on the stepped portion 19 of the attachment 11. The engagement recesses 31 of the core member 25 are engaged with the projections 17 of the attachment 11 as follows. That is, the washing member 23 is moved relative to the attachment 11 in the axial direction so that the axial portion 13 of the attachment 11 is inserted into the through hole 27 of the washing member 23 from an end portion thereof for fitting. Thereby, the shaft portion 13 of the attachment 11 is received in the through hole 28 of the core member 25. Prior to this, the washing member 23 is located relative to the attachment 11 such that both the projections 17 of the attachment 11 will engage with, that is, will be received in the axial portions 33 of both the engagement recesses 31 of the core member, respectively. The projection 17 of the attachment 11 received in the axial portion 33 reaches the circumferential portion 35 via the axial portion 33 of the engagement recess 31 as the washing member 23 moves relative to the attachment 11. Next, when the washing member 23 is turned around its axis, the projection 17 of the attachment 11 relatively moves along the circumferential portion 35 of the engagement recess 31, and comes upon one of the opposite ends of the circumferential portion 35. At this time, the end (lower end) of the core member 25 contacts the stepped portion 19 of the attachment 11, and one end (lower end) of the washing member 23 contacts the disc plate 15 of the attachment 11. In this way, the projections 17 of the attachment 11 are positioned in the circumferential portions 35 of the engagement recess 31. Thereby, the washing member 23 is prevented from slipping out from the attachment 11 during use. When the projections 17 of the attachment 11 engage with the circumferential portions 35 of the engagement recesses 31, more specifically, the projections 17 come upon the ends of the circumferential portions 35, the torque of the attachment 11 in the case that the attachment 11 is rotated in either one of normal and reverse directions is transmitted to the washing member 23 via the core member 25. When the core member 25 is interposed, it is possible to prevent damage and breakage of the hole wall, resultant idle rotations of the washing member, etc., as would occur if the projections 17 of the attachment 11 are engaged with the hole wall of the washing member 23 for rotating it. Early exchange of the washing member 23 owing to such damage or breakage can also be avoided.

Since the washing member 23 has the through hole 27 opened to the opposite ends thereof and the engagement recesses 31 of the core member 25 are provided in its opposite end portions, the assembly 5 can be fitted to the attachment 11 in the same manner as mentioned above, even if its opposite end portions are reversed. The assembly 5 is usefully fitted with the opposite end portions reversed, when one end portion (upper end portion) of the washing member 23 is worn out through use, or when the detergent moves to the other end portion (lower end portion) of the washing member 23 during washing and thus the detergent becomes thin in that upper end portion thereof. Thereby, washing can be done with the unworn end portion of the washing member 23, and washing can be done with the end portion abundant with the detergent. The assembly 5 can be removed from the attachment 11 by performing an operation reverse to that by which it is fitted to the attachment 11, that is, by reversely turning the assembly 5 relative to the attachment 11, thereby locating the projection 17 of the attachment 11 at the intersecting position between the circumferential portion 35 and the axial portion 33 of the engagement recess 31 of the core member 25, and then pulling out the assembly 5 from the attachment 11.

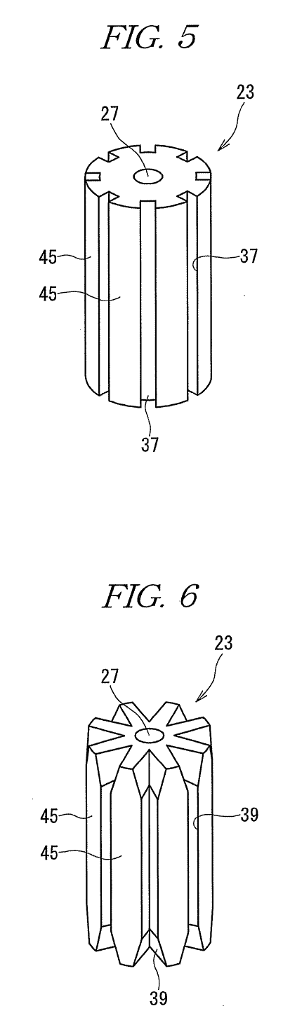

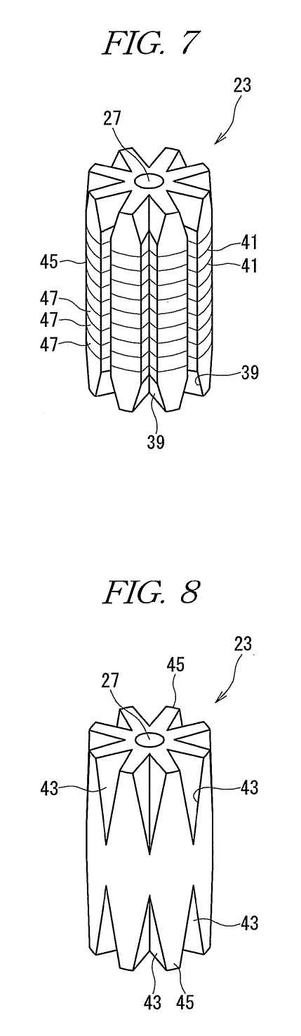

The washing member 23 may be a cylindrical sponge having a plurality of vertical groove 37 (FIG. 5). These vertical grooves 37 are arranged spaced from each other in the circumferential direction of the sponge, extend from one of both the end faces to the other of the sponge, and are opened at the outer peripheral face of the sponge. The vertical groove 37 has a rectangular cross sectional shape. Vertical grooves 39 having a V-like cross sectional shape may be employed instead of the rectangular cross sectional shape (FIG. 6). In addition to the vertical grooves 39 having the V-like cross sectional shape, the sponge may also have plural cuts 41 extending in the circumferential direction thereof (FIG. 7). Alternatively, the sponge may have plural notches 43 provided in the opposite end portions thereof (FIG. 8). When the vertical grooves 37, 39 or the notches 43 are provided, ridge-like projections 45 can be appeared between the vertical grooves 37, 39 and between the notches 43. Each projection 45 can be divided into a plurality of small segments 47 by providing the cuts 41. Since these projections 45 and the small segments 47 are flexible and thus exhibit particularly rod-like or mesh-like shapes, they easily closely contact the surface of the object to be washed, such as an eating utensil or a cooking utensil made of wires or thin pipes, so they exhibit excellent dirt-wiping off power. The cross sectional shape of the vertical grooves 37, 39 forming the projections 45 and the number of the cuts 41 defining the small segments 47 can be appropriately determined under consideration of the kinds and the sizes of the objects to be washed, etc.

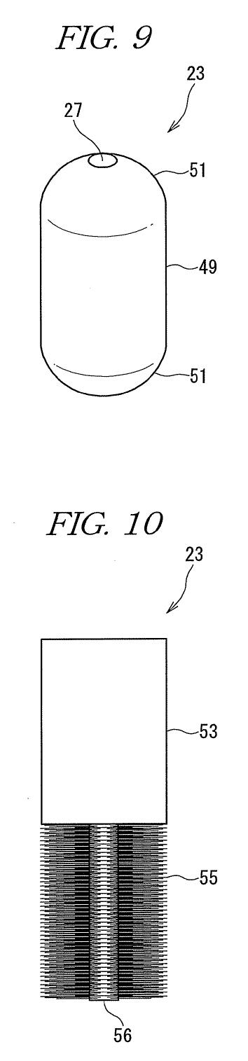

Meanwhile, the washing member 23 may be made of a sponge composed of a cylindrical portion 49 and a pair of semispherical portions 51 continued to the opposite ends of the cylindrical portion as shown in FIG. 9. In this example, a through hole 27 extend through the cylindrical portion 49 and both the semispherical portions 51 along their axes. This washing member 23 is suitable for washing become-narrower glasses or bottom-deep vessels. Further, the washing member 23 may be made of a cylindrical sponge 53 and a cylindrical brush 55 as shown in FIG. 10. According to this washing member 23, the brush 55 makes rough washing, and the sponge 53 makes minute washing. In the washing member 23 shown in FIG. 10, the core member 25 is disposed to extend through the through hole of the sponge 53 and a tubular core 56 of the brush 55.

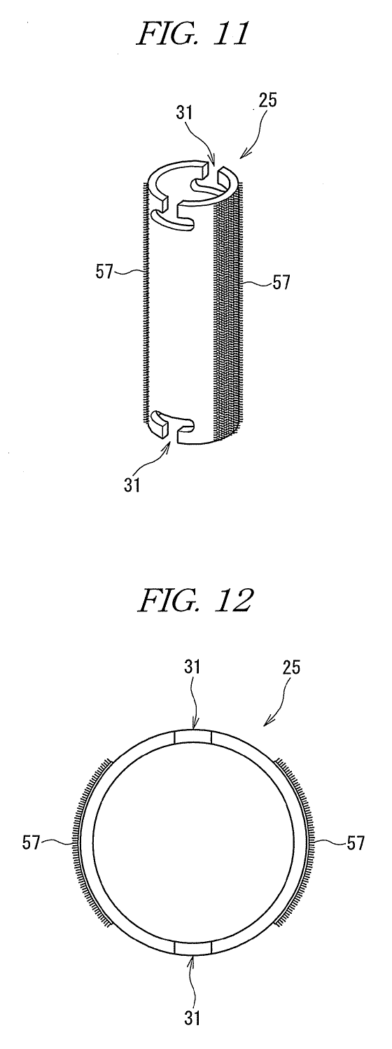

Incidentally, the core member 25 disposed inside the through hole 27 of the washing member 23 can be fixed to the hole wall of the through hole 27 via an adhesive applied to the peripheral face of the core member or a double-adhesive tape wound around the peripheral face. Alternatively, as shown in FIG. 11 and FIG. 12, the core member 25 can be fixed to the hole wall of the sponge via a number of hooks 57 provided on the peripheral face (cylindrical face) of the core member 25. These hooks 57 can be provided on the peripheral face of the core member 25 by attaching a hook tape of a Velcro (Velcro: Trade name) fastener to the peripheral face of the core member 25. Since the sponge has a number of small voids, a number of the hooks 57 are caught by peripheral edges of the voids opened to the hole wall of the sponge, and thereby the core member 25 is fixed to the hole wall.

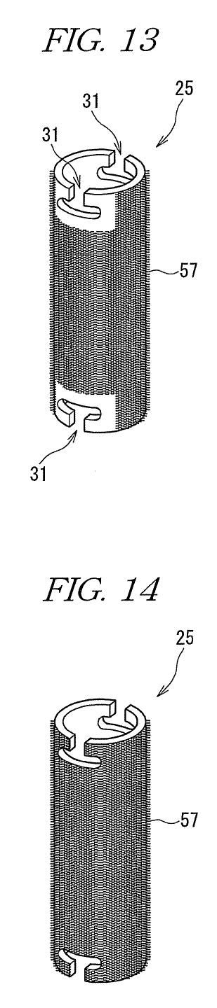

In the embodiment shown in FIG. 11 and FIG. 12, a number of the hooks 57 are provided in two areas opposed to each other on the cylindrical face of the core member 25. Alternatively, a number of the hooks 57 are provided in the entire area of the cylindrical face of the core member 25 except the area around the engagement recesses 31 at the opposite end portions thereof (FIG. 13), or over the entire area of the cylindrical face (FIG. 14).

### Mounting Device for the Assembly

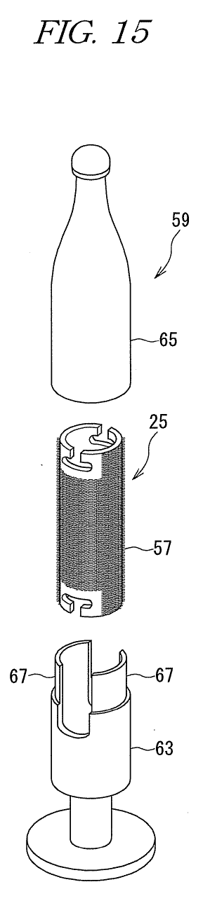

An operation of assembling the assembly 5 by disposing the core member 25 into the through hole 27 of the washing member 23 can be done with use of an assembling device 59 shown in FIG. 15. The assembly 5 to be assembled with the assembling device 59 may be made of a core member 25 and a washing member 23 both being fresh, or may be made of the core member detached from a washing member 23 having exhausted the lifetime and a fresh, unused washing member. In either of the cases, the assembly 5 can be easily assembled by a user of the washing device 1.

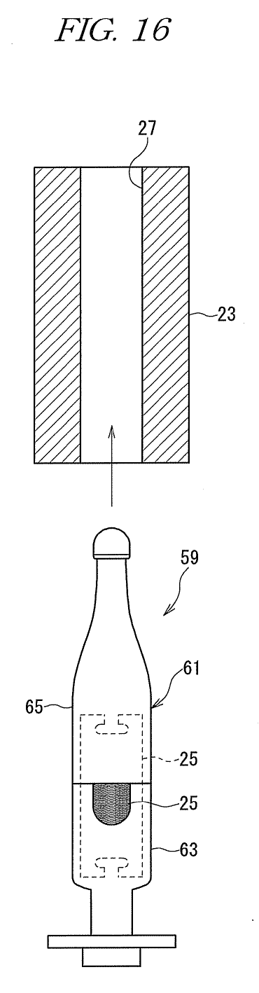

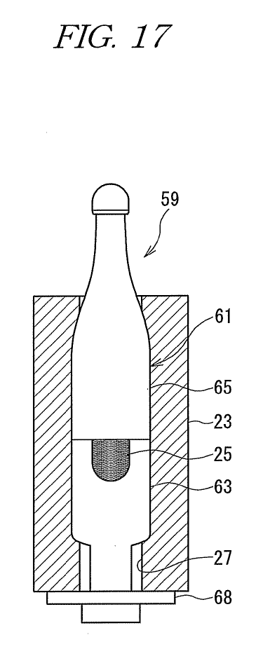

The assembling device 59 has a slender casing 61 with a round cross sectional shape (See FIG. 16). The casing 61 has a cylindrical space, which can receive the core member 25 therein. The core member 25 is disposed inside the cylindrical space coaxially with the casing 61. Further, the casing 61 has a smooth outer peripheral face. And, the casing 61 has such a outer diameter as to be inserted into the through hole 27 of the washing member 23, and the size longer than the through hole 27 of the washing member 23 (See FIG. 17).

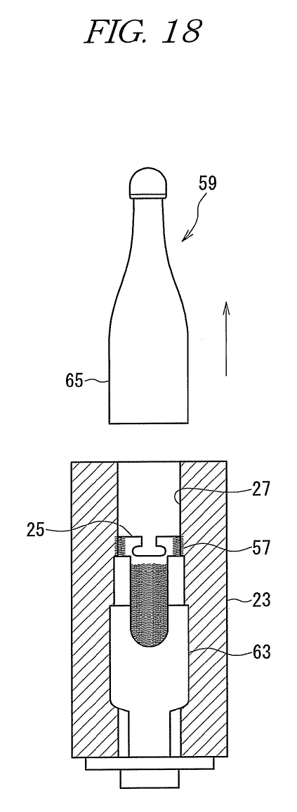

As shown in FIG. 15, the casing 61 comprises two portions separable from each other, that is, a body portion 63 and a cap portion 65. The cylindrical space for receiving the core member 25 is defined by both the portions 63 and 65 together. The body portion 63 has a pair of engagement portions 67 engageable with the cap portion 65, and when the body portion 63 engages with the cap portion 65 in the engagement portions 67, both the portions 63, 65 are integrated. Both the end portions 63, 65 have such sizes that the core member 25 may be partially exposed outside when the casing 61 having the core member 25 received therein is divided into the opposite portions 63, 65 (See FIG. 18).

Referring to FIG. 15 to FIG. 19, the assembly 5 composed of the washing member 23 made of the cylindrical sponge and the core member 25 with the numerous hooks (the core member 25 shown in FIG. 13) can be assembled as follows by using the assembling device 59.

The core member 25 is disposed inside the body portion 63 of the casing 61, and then the cap portion 65 is engaged with the engaging portions 67 of the body portion 63, thereby integrating the opposite portions 63, 65 (FIG. 15, FIG. 16). Next, the casing 61 having the core member 25 received therein is inserted into the through hole 27 of the washing member 23 from the cap portion 65 thereof (FIG. 17). With this insertion, the through hole 27 is pressed and spread radially. The opposite portions 63, 65 of the casing 61 are partially projected outside from the opposite ends of the through hole 27, respectively. The cap portion 65 is preferably tapered as in the example shown so that it can be easily passed through the through hole 27. Further, a stopper 68 is preferably provided for the body portion 63 of the casing 61 (See FIG. 17). When the core member 25 inside the casing 61 which is passed through the through hole 27 of the washing member 23 is located in an axially central portion of the through hole 27, the stopper 68 is brought into contact with the washing member 23. This contact prevents further movement of the casing 61 inside the through hole 27.

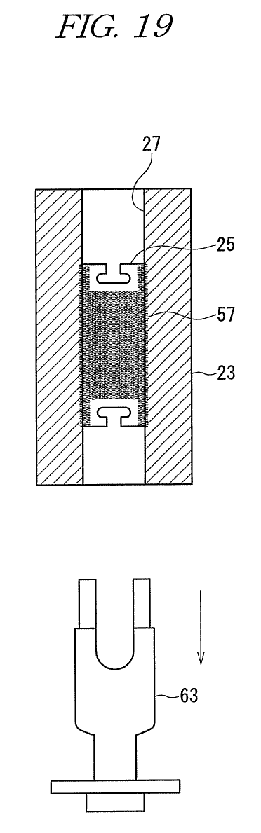

Next, the cap portion 65 is pulled out from the through hole 27 of the washing member 23 (FIG. 18). As a result, the upper end portion of the core member 25 is exposed from the body portion 63 remaining inside the through hole 27, and the hooks 57 in that upper end portion are caught by the hole wall of the through hole 27. Finally, the body portion 63 is pulled out from the through hole 27 (FIG. 19). Thereby, the core member 25 is positioned in the axially central portion of the through hole 27 of the washing member 23, all the remaining hooks 57 are caught by the hole wall of the through hole 27. Consequently, the core member 25 is fixed to the washing member 23.

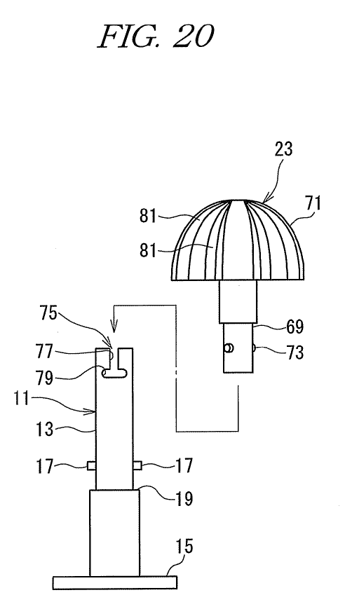

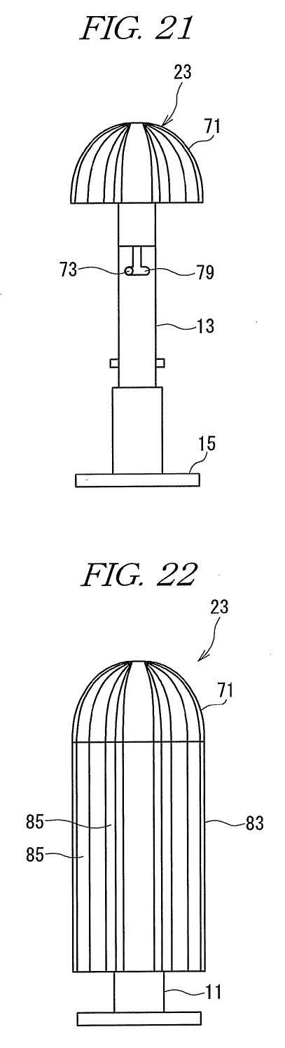

Next, another embodiment of the washing member 23 is shown in FIG. 20 and FIG. 21. This washing member 23 comprises a shaft portion 69 and a semispherical sponge portion 71 fixed to an end portion of the shaft portion 69, and the shaft portion 69 has at least one projection 73 (two projections in the illustrated embodiment). Further, the attachment 11 to which this washing member 23 is fitted has a pair of engagement recesses 75 in a free end portion (upper end portion) of a shaft portion 13 thereof. And, the upper end portion of the attachment 11 can receive a part (lower end portion) of the shaft portion 69 of the washing member 23. The engagement recesses 75 of the shaft portion 13 of the attachment 11 are engageable with the two projections 73 of the shaft portion 69 of the washing member 23, when the shaft portion 69 of the washing member 23 is received in the upper end portion of the attachment 11. Each of the engagement recesses 75 provided in the attachment 11 has a structure similar to that of the engagement recess 31 provided in the core member 25, and the recess comprises a notch composed of an axial portion 77 and a circumferential portion 79 continued thereto. Instead of the above notch, a groove opened to an inner peripheral face of the upper end portion of the attachment 11 can be employed.

The washing member 23 can be fitted to the attachment 11 by inserting the lower end portion of its shaft portion 69 into the upper end portion of the shaft portion 13 of the attachment 11. On this fitting, each projection 73 of the washing member 23 engages with the axial portion 77 of the engagement recess 75 of the attachment 11, reaches the circumferential portion 79 through the axial portion, and then is brought into contact with an end of the circumferential portion 79. Thereby, the shaft portion 69 of the washing member 23 can be prevented from being pulled out from the upper end portion of the shaft portion 13 of the attachment 11. In this embodiment, the sponge portion 71 is fitted to the attachment 11 via the shaft portion 69, and the projection 17 of the attachment 11 is not used.

According to this embodiment, as the attachment 11 is rotated by actuating the motor 3, the sponge portion 71 is rotated. Washing with the sponge portion 71 is suitable particularly for cups, glasses and bottom-deep eating utensils, for example. The semispherical sponge portion 71 preferably has a plurality of grooves 81 extending radially from its top.

As shown in FIG. 22, a washing member 83 made of a cylindrical sponge can be arranged for the attachment 11, in addition to the washing member 23 having the sponge portion 71. The washing member 83 is arranged under and adjacent to the washing member 23. This washing member 83 has the same radius as that of the sponge portion 71. Preferably, the washing member 83 has a plurality of grooves 85 extending axially as in the same with the sponge portion 71. The core member 25 (FIG. 4) is located in a through hole of the washing member 83 in the same manner as for the washing member 23 shown in FIG. 1, and is fitted to the attachment 11 in the same manner as for the washing member 23 shown in FIG. 1.

### Mounting Device for the Washing Device

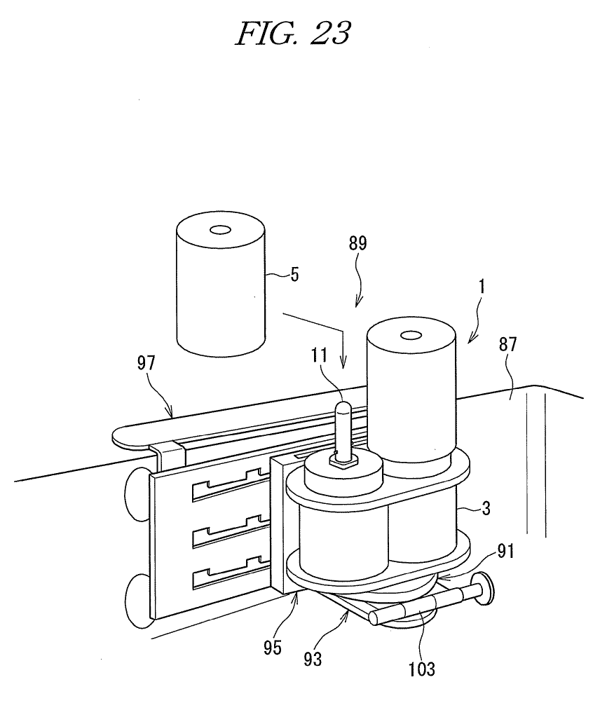

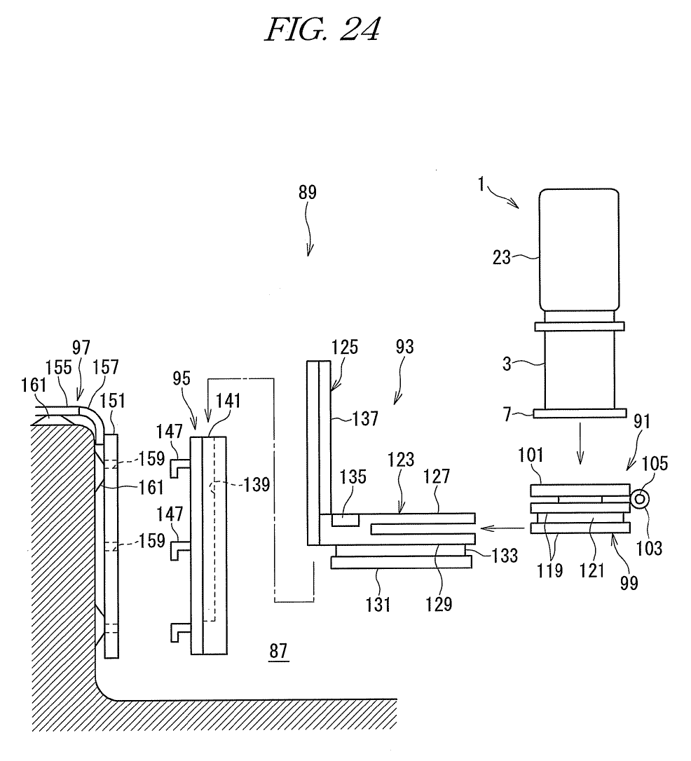

Next, referring to FIG. 23 and FIG. 24, a mounting device 89 for mounting the washing device 1 to a sink 87 is shown. The mounting device 89 comprises a pedestal 91 for supporting the washing device 1, a support member (first support member) 93 for supporting the pedestal 91, a support member (second support member) 95 for supporting the first support member 93, and a support member (third support member) 97 for supporting the second support member 95 to the sink 87.

### Pedestal

As shown in FIG. 24, the pedestal 91 comprises a base portion 99 and a mounting portion 101 on which the washing device 1 is to be mounted. The base portion 99 and the mounting portion 101 both have a round planar shape. The mounting portion 101 is placed on the base portion 99, and pivotably fitted to the base portion 99 via a hinge 103. The washing device 1 is placed on the mounting portion 101, and its connecting plate 7 for both the motors 3 is fixed onto the mounting portion 101 by using screws (not shown), for example.

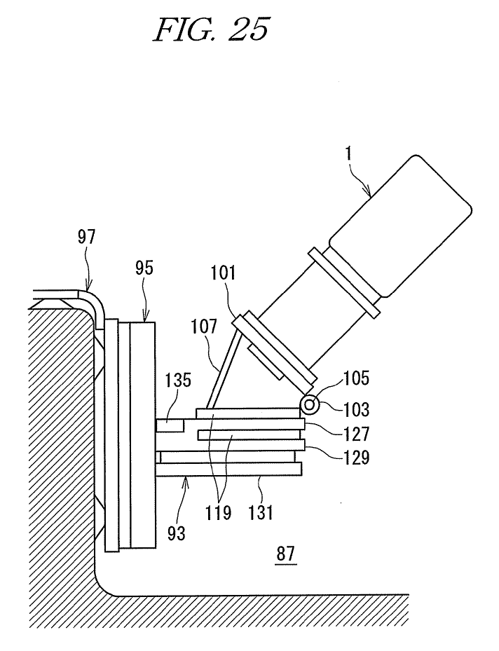

As shown in FIG. 25, the mounting portion 101 pivotably fitted to the base portion 99 can be swung around a shaft 105 of the hinge 103. When the mounting portion 101 is swung, the posture of the washing device 1 fitted thereto can be changed from a vertical state to a tilted state in the figure. The above tilted state of the mounting portion 101 can be maintained by a tilted state-maintaining means, such as a diagonal brace 107 composed of rod-like members, planar members or the like, for example. The diagonal brace 107 can be fitted to the lower face of the mounting portion 101.

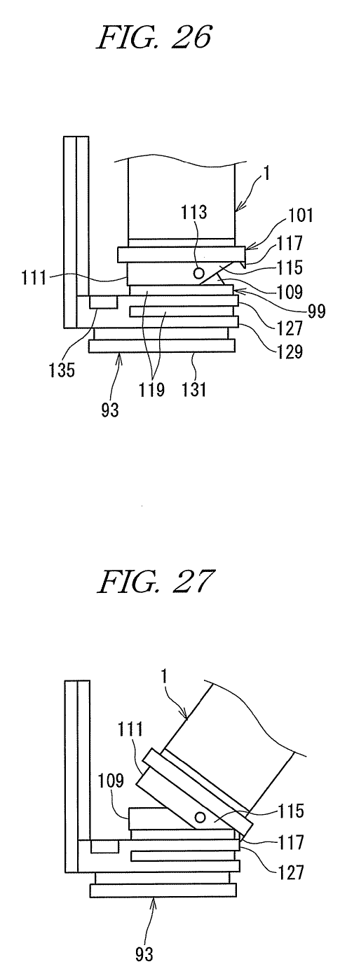

Referring to FIG. 26 and FIG. 27, another embodiment of the pedestal 91 is shown. A base portion 99 and amounting portion 101 of the pedestal 91 are connected to each other via a pair of planar brackets 109, 111 fixed to them, respectively, and a pin 113 passing through the brackets so that the mounting portion 101 can be swung around the pin 113. The bracket 111 of the mounting portion 101 has a tapered tip portion 115. The bracket 111 contacts the base portion 99 except its tip end portion 115, and a space exists between the tip end portion 115 and the base portion 99. Owing to this, the mounting portion 101 can be swung in such a direction in which the tip end portion 115 approaches the base portion 99, and that the swinging is stopped when the tip end portion 115 is brought into contact with the base portion 99. Therefore, the tip end portion 115 functions as a stopper. On swinging the mounting portion 101, the posture of the washing device 1 fixed to the mounting portion 101 can be changed from the vertical state to the tilted state in the figure. The tilted state is maintained by contacting the tip end portion 115 of the bracket 111 to the base portion 99. When a hook 117 which can be fixedly fitted to the first support portion 93 for supporting the pedestal 91 is provided for the mounting portion 101 of the pedestal 91, the washing device 1 can be still maintained in the above tilted state even if an external force acts upon the washing device 1. Further, the mounting portion 101 may be fixed to the base portion 99, instead of the above embodiment in which the mounting portion 101 is swingably connected to the base portion 99.

Referring to FIG. 24 again, the base portion 99 of the pedestal 91 comprises a pair of upper and lower round planar portion 119 and a flat cylindrical portion 121 continued to the planar portions 119. The cylindrical portion 121 has a diameter smaller than that of the planar portions 119.

### First Support Member

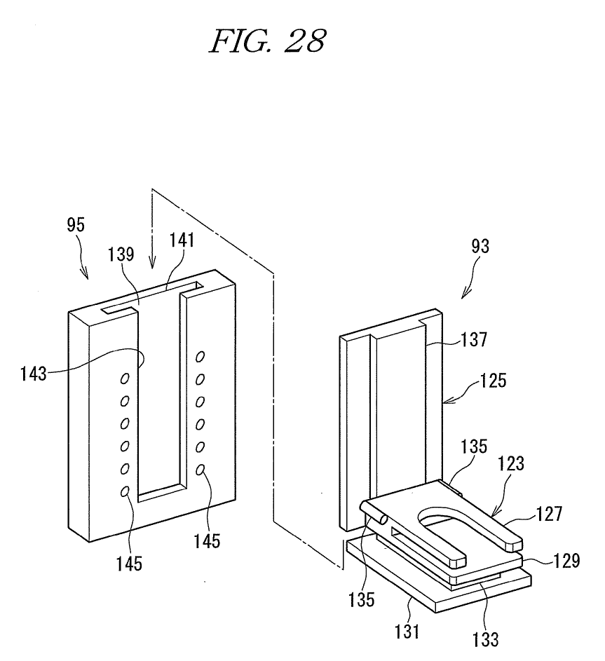

As shown in FIG. 24 and FIG. 28, the first support member 93 for supporting the pedestal 91 comprises a horizontal portion 123 and a vertical portion 125 continued to the horizontal portion 123 and vertically extending. The horizontal portion 123 comprises a yoke portion 127, a planar portion 129 positioned under the yoke portion 127 and facing the yoke portion, and a second planar portion 131 positioned under the planar portion 129 and continued to and opposing the planar portion.

The yoke portion 127 can receive the cylindrical portion 121 of the base portion 99 of the pedestal 91 through its tip end. When the cylindrical portion 121 of the base portion 99 is received in the yoke portion 127, the base portion 99 of the pedestal 91 is placed on the planar portion 129, and its two planar portions 119 hold the yoke portion 127 therebetween. As a result, the base portion 99 of the pedestal 91 is received in the horizontal portion 123. Through this reception, the pedestal 91 can be turned around the axis of the pedestal or horizontal portion 123 on the horizontal portion 123 of the first support member 93, so that the posture of the washing device 1 fixed to the pedestal 91 can be changed.

The second planar portion 131 of the first support member 93 has a thick portion 133 continued to the planar portion 129. Further, a pair of tubular casings 135 having screw grooves are attached to both sides of the yoke portion 127, respectively, and pins (not shown) having screw threads are screwed into the screw grooves. The casings 135 are opened toward the vertical portion 125. The pin can be projected from the casing 135 by turning them with use of a screw driver, for example.

The vertical portion 125 of the first support member 93 has almost the same outer shape as that of the second planar portion 131 in the horizontal portion 123. That is, the vertical portion 125 is made of a plate, and has a thick portion 137 extending vertically along the vertical portion on one surface thereof, that is, one surface facing the horizontal portion 123.

### Second Support Member

As shown in FIG. 24 and FIG. 28, the second support member 95 for supporting the first support member 93 exhibits a planar shape as a whole, and has a vertically extending recess 139. The recess 139 has a rectangle and opened upper end 141 and a rectangle opening 143 continued to the opened upper end 141 and vertically extending. The recess 139 forms a receiving portion capable of receiving the vertical portion 125 of the first support member 93 from the upper side thereof. When the vertical portion 125 is received in the recess 139 by inserting the vertical portion 125 of the first support member 93 into the recess 139, the thick portion 137 of the vertical portion 125 is received in the opening 143 of the recess 139. At this time, the washing device 1 is held in a vertical state (the state shown in FIG. 24). Further, the recess 139 can receive the second plate portion 131 of the first support member 93 from the upper side thereof. When the second plate portion 131 is received in the recess 139 by inserting the second plate portion 131 into the recess 139, the thick portion 133 of the second planar portion 131 is received in the opening 143 of the recess 139. At this time, the washing device 1 is held in a horizontal state. Consequently, the posture of the washing device 1 can be changed from the vertical state to the horizontal state.

The second support member 95 is provided with plural holes 145 on opposite sides of the opening 143 of the recess 139, respectively. The plural holes 145 are arranged spaced vertically. These holes 145 can receive the pins projecting from the casings 135 of the first support member 93 in the state that the vertical portion 125 of the first support member 93 is received in the recess 139 of the second support member 95. The holes 145 to which the pins are to be received are selected, the vertical portion 125 of the first support member 93 inside the recess 139 is vertically moved to the height position of the selected holes 145, and the pins are advanced into the selected holes 145, so that the first support member 93 is held at the height position of the selected holes 145 via the pins. Consequently, the height position of the first support member 93 can be changed. Meanwhile, the second support member 95 is provided with plural hooks 147 on a side opposite to the opening 143 of the recess 139. These hooks 147 are arrayed in plural stages (three stages in the illustrated embodiment) in the vertical direction.

### Third Support Member

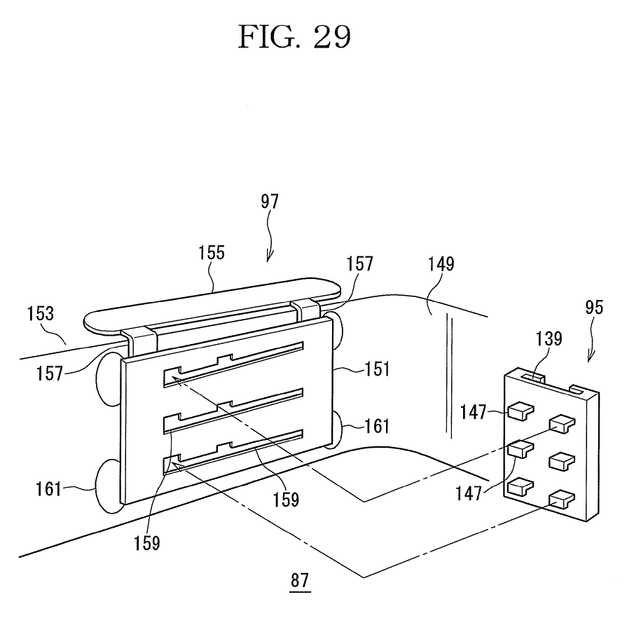

As shown in FIG. 24 and FIG. 29, the third support member 97 for supporting the second support member 95 comprises a plate 151 disposed along a wall face 149 of the sink 87, a plate 155 placed on a top face 153 of the sink 87, and a pair of connecting members 157 connecting these two plates 151, 155 to each other.

Plural slits 159 are arranged in the plate 151, extending horizontally in a lateral direction along the wall face 149 of the sink. These slits 159 are arrayed vertically in plural stage (three stages in the illustrated embodiment). The hooks 147 at the plural stages of the second support member 95 can be hooked to these plural-stage slits 159, respectively. The second support member 95 is supported by the third support member 97 by hooking the hooks 147 to the slits 159. Further, the hooks 147 hooked to the slits 159 can be slid along the slits 159. By this sliding, the lateral position or the horizontal position of the second support member 95 can be changed relative to the third support member 97 inside the sink 87, and eventually the installing position of the washing device 1 supported by the second support member 95 can be changed. In addition, both the plates 151, 155 can be supplementarily fixed to the sink 87 by providing them with plural sucking discs 161.

The connecting member 157 for both the plates 151, 155 can be a single L-shaped plate having a relatively large wide can be employed, for example, instead of the embodiment shown in FIG. 29. Further, it may be that the plate 155 placed on the top face 153 of the sink 87 is omitted, and the connecting member 157 takes a role of the plate 155 instead. According to this, the plate 151 is hanged from the top face 153 of the sink 87 by means of the connecting member 157. Further, when the plate 155 is omitted, wires or thin pipes are bent to form portions corresponding to the connecting member 157 and the plate 151.

According to the mounting device 89 for the above-mentioned washing device 1, the washing device 1 can be temporarily removed from the inside of the sink 87 together with a part of the mounting device 89, if necessary. That is, the washing device 1 can be temporarily taken out from the inside of the sink 87, together with the pedestal 91 when the base portion 99 of the pedestal 91 is pulled out from the yoke portion 127 of the first support member 93, or together with the pedestal 91 and the first support member 93 when the vertical portion 125 of the first support member 93 is pulled out from the recess 139 of the second support member 95, or together with the pedestal 91, the first support member 93 and the second support member 95 when the hooks 147 of the second support member 95 are removed from the slits 159 of the third support member. Thereby, the space inside the sink 87 can be effectively utilized.

Meanwhile, the washing device to be attached to the sink 87 by the mounting device 89 is not limited to the washing device 1 shown in FIG. 1, but it may be another arbitrary washing device, including the prior art ones.

### EXPLANATION OF REFERENCE NUMERALS

1 washing device
3 motor
5 assembly
7 plate
9 rotating shaft
11 attachment
17 projection
23 washing member
25 core member
27 through hole
28 through hole
31 engagement recess
33 axial portion
35 circumferential portion
59 assembling device
61 casing
89 mounting device
91 pedestal

1. A core member for a washing device comprising a motor and a washing member, the motor comprising a rotating shaft and a rotating shaft attachment fitted to the rotating shaft and having at least one projection, the washing member being vertically detachably fitted to the rotating shaft attachment and having a through hole capable of receiving the rotating shaft attachment so as to fit it to the rotating shaft attachment, the core member being disposed in the through hole of the washing member of the washing device and fixed to a hole wall of the through hole for transmitting a torque of the rotating shaft attachment to the washing member,
wherein the core member has a through hole capable of receiving the rotating shaft attachment, and has opposite end portions provided with engagement recesses, each of which is engageable with the projection of the rotating shaft attachment, and the washing member is usable in a state that it is turned upside down.

2. The core member according to claim 1, wherein the core member comprises a cylindrical body, and the engagement recess comprises a slit or grooves which is opened to an end face of the cylindrical body, and the slit or groove comprises an axial portion extending in an axial direction of the cylindrical body and a circumferential portion crossing with the axial portion and extending in a circumferential direction of the cylindrical body.

3. An assembly to be applied to a washing device, the washing device comprising a motor having a rotating shaft and a rotating shaft attachment which is fitted to the rotating shaft and has at least one projection, the assembly comprising a washing member and a core member, the washing member being vertically detachably fitted to the rotating shaft attachment and having a through hole capable of receiving the rotating shaft attachment so that the washing member may be fitted to the rotating shaft attachment, and the core member being disposed inside the through hole of the washing member and fixed to a hole wall of said through hole for transmitting a torque of the rotating shaft attachment to the washing member,
wherein the core member has a through hole, which is capable of receiving the rotating shaft attachment, and opposed end portions with engagement recesses, each of which is engageable with the projection of the rotating shaft attachment, and the washing member is usable in a state that it is turned upside down.

4. The assembly according to claim 3, wherein the core member is positioned in an axially central portion of the through hole of the washing member.

5. The assembly according to claim 3, wherein the core member comprises a cylindrical body, and the engagement recesses comprise grooves or notches having axial portions which are open to respective end faces of the cylindrical body and extending in an axial direction of the cylindrical body and circumferential portions crossing with the axial portions and extending in a circumferential direction of the cylindrical body.

6. The assembly according to claim 3, wherein the washing member comprises a sponge, the through hole of the washing member has a round cross section, and the core member has a cylindrical face provided with a number of hooks which can be caught by the hole wall of said through hole.

7. The assembly according to claim 3, wherein the washing member comprises a cylindrical sponge, and the sponge has a plurality of vertical grooves provided open to the outer peripheral face thereof and extending in the axial direction thereof.

8. The assembly according to claim 7, wherein the vertical grooves are of a rectangular or V-like cross sectional shape.

9. The assembly according to claim 7, further comprising a plurality of cuts extending in the circumferential direction of the sponge.

10. The assembly according to claim 3, wherein the washing member comprises a cylindrical sponge, and the sponge has a plurality of notches provided at its opposite end portions and opened to the outer peripheral face thereof.

11. The assembly according to claim 3, wherein the washing member is made of a sponge which comprises a cylindrical portion and a pair of semispherical portions continued to the opposite end portions of the cylindrical portion, respectively, and the through hole extends through the cylindrical portion and both the semispherical portions.

12. A washing device comprising:
a motor and an assembly,
the motor comprising a rotating shaft and a rotating shaft attachment fitted to the rotating shaft and having at least one projection,
the assembly comprising a washing member and a core member, the washing member being vertically detachably fitted to the rotating shaft attachment and having a through hole capable of receiving the rotating shaft attachment so that the washing member may be fitted to the rotating shaft attachment, and the core member being disposed inside the through hole of the washing member and fixed to a hole wall of said through hole for transmitting a torque of the rotating shaft attachment to the washing member,
wherein the core member having a through hole capable of receiving the rotating shaft attachment and opposite end portions provided with engagement recesses, each of which is engageable with the projection of the rotating shaft attachment and the washing member is usable in a state that it is turned upside down.

13. (canceled)

14. (canceled)

15. (canceled)

16. An assembling device for the assembly composed of the washing member and the core member as set forth in claim 3, wherein the assembling device comprises a casing which is capable of receiving the core member, is insertable into the through hole of the washing member and is longer than the through hole of the washing member,
wherein the casing comprising two segments and separable from each other, wherein when the casing in which the core member is received is divided into the two segments, a part of the core member is exposed outside.

17. A mounting device for mounting a washing device to a sink,
the washing device comprising a motor and a washing member, the motor comprising a rotating shaft and a rotating shaft attachment fitted to the rotating shaft, and the washing member being fitted to the rotating shaft attachment,
the mounting device comprising a pedestal, a first support member, a second support member and a third support member,
the pedestal comprising a base portion and a fitting portion to which the washing device is fitted,
the first support member comprising a horizontal portion for receiving the base portion of the pedestal turnable around an axis thereof and a vertical portion (a back portion) continued to the horizontal portion and extending vertically,
the second support member having a receiving portion capable of receiving the vertical portion or the horizontal portion of the first support member, and
the third support member being adapted for supporting the second supporting member to the sink.

18. The mounting device according to claim 17, wherein the mounting portion of the pedestal is pivotably fitted to its base portion, and a maintaining means is provided for maintaining the posture of the mounting portion after the pedestal is pivotably moved.

19. The mounting device according to claim 18, wherein the maintaining means comprises a diagonal brace capable of being fitted to the mounting portion.

20. The mounting device according to claim 18, wherein the maintaining means comprises a stopper provided at the mounting portion.

21. The assembly according to claim 8, further comprising a plurality of cuts extending in the circumferential direction of the sponge.
